(19) United States
(12) Patent Application Publication
(10) Pub. No.: US 2024/0321016 A1
(43) Pub. Date: Sep. 26, 2024

(54) USER TERMINAL, SYSTEM, AND METHOD OF CONTROLLING USER TERMINAL

(71) Applicant: TOYOTA JIDOSHA KABUSHIKI KAISHA, Toyota-shi (JP)

(72) Inventor: Gentaro ARAKI, Tokyo (JP)

(73) Assignee: TOYOTA JIDOSHA KABUSHIKI KAISHA, Toyota-shi (JP)

(21) Appl. No.: 18/413,493

(22) Filed: Jan. 16, 2024

(30) Foreign Application Priority Data
Mar. 23, 2023 (JP) 2023-046765

(51) Int. Cl. G07B 15/02; G06Q 50/47

(52) U.S. Cl. CPC G07B 15/02; G06Q 50/47

(57) ABSTRACT

The mobile terminal (user terminal) includes a communication module (communication unit) that communicates with a server (first server) that manages electronic payment of transportation fares, and a display (display unit). The display displays information on excess charges for using transportation outside the valid range of the ticket. The communication module transmits information regarding payment of excess charges to the server when the user uses transportation outside the valid range.

### CROSS-REFERENCE TO RELATED APPLICATION

This application claims priority to Japanese Patent Application No. 2023-046765 filed on Mar. 23, 2023, incorporated herein by reference in its entirety.

### BACKGROUND

### 1. Technical Field

The present disclosure relates to a user terminal, a system, and a method of controlling a user terminal.

### 2. Description of Related Art

Japanese Unexamined Patent Application Publication No. 2016-038858 (JP 2016-038858 A) discloses a system that allows buses to be used with a commuter pass displayed on a mobile terminal. If the user goes outside of a commuter pass section, an alert message including an excess fare will be displayed on the mobile device. In this case, the user needs to put the displayed excess fare into a fare box when getting off the bus.

### SUMMARY

In the system described in JP 2016-038858 A, the user needs to pay the excess fare in cash, which takes time and effort. Therefore, it is desired to reduce the amount of time and effort required to pay excess fares on transportation facilities.

The present disclosure has been made to solve the above issue, and a purpose of the present disclosure is to provide a user terminal, a system, and a method of controlling a user terminal that can reduce time and effort required to pay excess fares on transportation facilities.

A user terminal according to a first aspect of the present disclosure is a user terminal of a user who uses a transportation facility using a ticket to which a valid range is set. The user terminal includes:
a communication unit that communicates with a first server that manages electronic payment of a boarding fare for the transportation facility; and
a display unit.

The display unit displays information on an excess fare for using the transportation facility outside the valid range.

When the user uses the transportation facility outside the valid range, the communication unit transmits information on payment of the excess fare to the first server.

In the user terminal according to the first aspect of the present disclosure, as described above, when the user uses the transportation facility outside the valid range, the communication unit transmits the information on payment of the excess fare to the first server that manages electronic payment. Accordingly, the excess fare is automatically paid by electronic payment without the user paying the excess fare in cash. As a result, it is possible to reduce the amount of time and effort required to pay excess fares on transportation facilities. Furthermore, since the information on the excess fare is displayed on the display unit, it is possible to suppress the excess fare from being paid without the user knowing the amount of the excess fare.

In the user terminal according to the first aspect, the display unit may be
configured such that information on a destination is able to be input through an input operation by the user, and
may display information on the excess fare that is determined based on the valid range and the destination.

With this configuration, the user can obtain the information on the excess fares in advance.

In the user terminal according to the first aspect, when the user is located within the valid range and at or within a predetermined distance from a boundary of the valid range, the display unit may display a notification indicating that the user is approaching an area outside the valid range.

With this configuration, it is possible to suppress the user from going out of the valid range.

A system according to a second aspect of the present disclosure is a system including the user terminal according to the first aspect. The system includes
a user terminal, and
a second server that communicates with the user terminal.

The user terminal
displays headcount information on the number of people who are allowed to use the ticket and permitted terminal information on another user terminal that is permitted to use the ticket, allows inputting permission information for permitting the other user terminal to use the ticket through an input operation by the user, and
transmits the input permission information to the second server.

When the number of other user terminals that are permitted to use the ticket is smaller than the number of people who are allowed to use the ticket, the second server transmits a permission signal to the other user terminal to permit use of the ticket.

In the system according to the second aspect, when the number of other user terminals that are permitted to use the ticket is smaller than the number of people who are allowed to use the ticket, the second server transmits the permission signal to the other user terminal to permit use of the ticket. Accordingly, even when another user who is permitted to use the ticket goes out of the valid range of the ticket, it is possible to reduce the time and effort required to pay the excess fare.

A method of controlling a user terminal according to a third aspect of the present disclosure is a method for controlling a user terminal of a user who uses a transportation facility using a ticket to which a valid range is set. The method includes the steps of:
displaying information on an excess fare for using the transportation facility outside the valid range; and
when the user uses the transportation facility outside the valid range, transmitting information on payment of the excess fare to a server that manages electronic payment of a boarding fare for the transportation facility.

In the method of controlling a user terminal according to the third aspect of the present disclosure, as described above, when the user uses the transportation facility outside the valid range, the communication unit transmits the information on payment of the excess fare to the server that manages electronic payment. Accordingly, it is possible to provide a method of controlling a user terminal that can reduce the amount of time and effort required to pay excess fares at transportation facilities. Furthermore, since the information on the excess fare is displayed on the display unit, it is possible to provide a method of controlling a user terminal that can suppress the excess fares from being paid without the user knowing the amount of the excess fares.

According to the present disclosure, it is possible to reduce the amount of time and effort required to pay excess fares on transportation facilities.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating the configuration of a system according to an embodiment;

FIG. 2 is a diagram illustrating the configuration of a server according to an embodiment;

FIG. 3 is a diagram illustrating the configuration of a mobile terminal according to an embodiment;

FIG. 4 is a diagram illustrating an example ticket according to one embodiment;

FIG. 5 is a sequence diagram illustrating control of the system according to one embodiment;

FIG. 6 is a diagram showing a screen displayed when approaching outside the valid range of the ticket;

FIG. 7 is a flowchart showing control for displaying excess charges from destination information;

FIG. 8 is a diagram showing an example of a screen displaying a destination input field and excess charges;

FIG. 9 is a sequence diagram showing control for allowing other terminals to use the ticket; and

FIG. 10 is a diagram showing an example of a screen for specifying a terminal that is permitted to use a ticket.

### DETAILED DESCRIPTION OF EMBODIMENTS

Hereinafter, an embodiment of the present disclosure will be described in detail with reference to the drawings. In the drawings, the same or corresponding parts are denoted by the same reference signs and the description thereof will not be repeated.

### Embodiment

### System Configuration

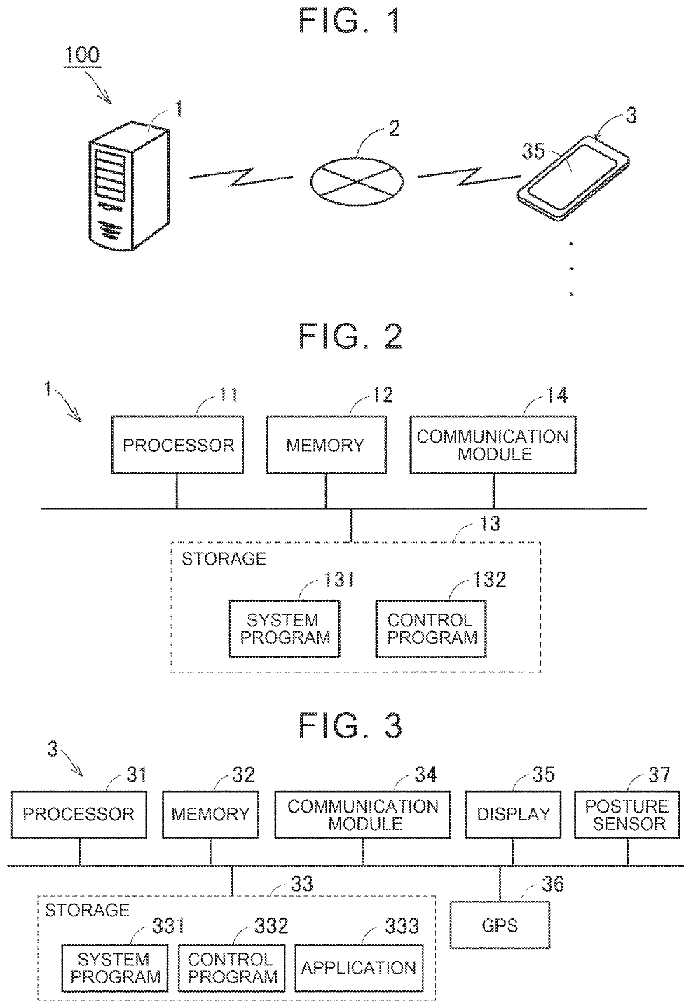

FIG. 1 is a diagram schematically showing the overall configuration of a system 100 according to an embodiment of the present disclosure. The system 100 includes a server 1 and a plurality of mobile terminals 3. The server 1 and the plurality of mobile terminals 3 communicate via the Internet 2. The server 1 is a server that manages electronic payment of boarding fees when users use transportation facilities (for example, buses, trains, etc.). Note that the mobile terminal 3 is an example of a “user device” of the present disclosure. Further, the server 1 is an example of a “first server”, a “second server”, and a “server” of the present disclosure.

FIG. 2 is a diagram showing an example of the configuration of the server 1. The server 1 includes, for example, a processor 11, a memory 12, a storage 13, and a communication module 14.

The processor 11 is, for example, a microprocessor such as a Central Processing Unit (CPU) or a Micro-Processing Unit (MPU). Memory 12 is volatile memory such as Random Access Memory (RAM). The processor 11 reads out a system program 131 and a control program 132 (described later), expands them into the memory 12, and executes them, thereby realizing various processes.

The storage 13 is a rewritable nonvolatile memory such as a hard disk drive (HDD), solid state drive (SDD), or flash memory. The storage 13 stores a system program 131 including an Operating System (OS) and a control program 132 including computer-readable codes necessary for control calculations.

Communication module 14 includes a communication interface with a network such as the Internet 2 (see FIG. 1). The communication module 14 is configured to be capable of bidirectional communication with external devices (such as a plurality of mobile terminals 3) of the server 1.

FIG. 3 is a diagram showing an example of the configuration of the mobile terminal 3. The mobile terminal 3 is a terminal carried by a user, and is, for example, a smartphone, a tablet, or a smart watch. The mobile terminal 3 may be a notebook personal computer (PC). The mobile terminal 3 includes, for example, a processor 31, a memory 32, a storage 33, a communication module 34, a display 35, a Global Positioning System (GPS) module 36, and an attitude sensor 37. Note that the communication module 34 and the display 35 are examples of a “communication unit” and a “display unit” of the present disclosure, respectively.

The processor 31 is, for example, a microprocessor such as a CPU or an MPU. Memory 32 is volatile memory such as RAM. The processor 31 implements various processes by reading out a system program 331, a control program 332, and an application 333 (described later), loading them onto the memory 32, and executing them.

The storage 33 is a rewritable nonvolatile memory such as a flash memory. The storage 33 stores a system program 331 including an OS, a control program 332 including computer-readable codes necessary for control calculations, and an application 333. Details of the application 333 will be described later.

Communication module 34 includes a communication interface that conforms to wireless communication standards. The wireless communication standard may be Long Term Evolution (LTE) such as 4G or 5G, wireless Local Area Network (LAN) such as Wireless Fidelity (Wi-Fi), or may be both of these. The communication module 34 is configured to be able to communicate bidirectionally with the server 1.

The display 35 is a mobile display such as organic Electro Luminescence (EL) or liquid crystal display. The display 35 is configured to display various information according to control instructions from the processor 31. In this example, the display 35 is a display with a touch panel that can accept user input operations.

The GPS module 36 acquires information (GPS information) indicating the current position of the mobile terminal 3 based on signals from a plurality of artificial satellites, and outputs the GPS information to the processor 31. Thereby, the GPS module 36 can acquire the user's location information. Note that the mobile terminal 3 may include a beacon receiver (not shown) instead of or in addition to the GPS module 36.

The attitude sensor 37 is, for example, a 3-axis acceleration sensor, a 3-axis gyro sensor, or a geomagnetic sensor. The attitude sensor 37 detects the attitude (rotational movement) of the mobile terminal 3 and outputs the detection result to the processor 31.

### Application

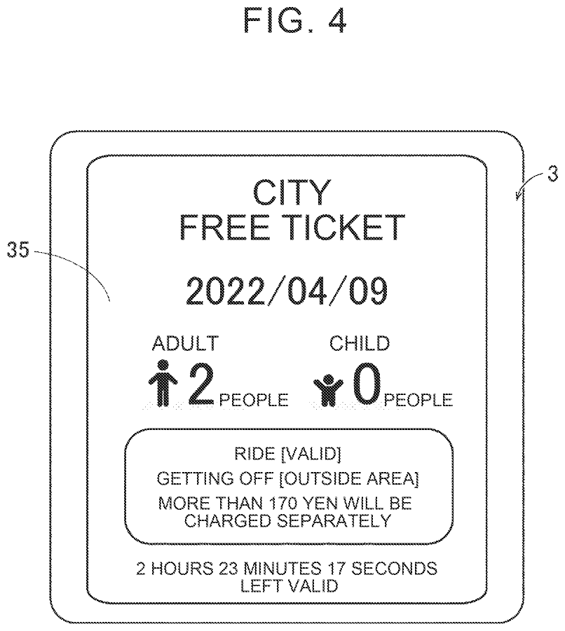

FIG. 4 shows a ticket (free ticket) displayed on the display when the application 333 is executed. A valid range is set for a ticket. In the example shown in FIG. 4, the valid range of the ticket is within the city. The ticket also includes the expiry date and time (Apr. 9, 2022 in FIG. 4), the number of people who can use it (two adults in FIG. 4), and the time until the expiration date (2 hours, 23 minutes, 17 seconds in FIG. 4) is written (set). Note that the ticket does not have to be a free ticket. For example, the ticket may be a commuter pass.

Furthermore, information indicating whether each of the boarding position and the alighting position is within the above-mentioned valid range is displayed on the ticket. In the example shown in FIG. 4, the getting-on position is within the valid range, so “valid” is displayed, and the getting-off position is outside the valid range, so “outside area” is displayed. Further, the excess charge for using the ticket outside the valid range (170 yen in FIG. 4) is displayed on the display 35.

Here, in the conventional system, the user needs to pay the excess fee in cash, which is time-consuming. On the other hand, it is desired to reduce the time and effort required to pay excess charges on transportation facilities (for example, buses, trains, etc.).

Therefore, in this embodiment, the communication module 34 of the mobile terminal 3 transmits information regarding the payment of excess fees to the server 1 when the user uses transportation outside the valid range of the ticket. Thereby, the excess charge is automatically paid by the server 1 from the user's account without the user paying the excess charge himself.

Sequence Control between Mobile Terminal and Server

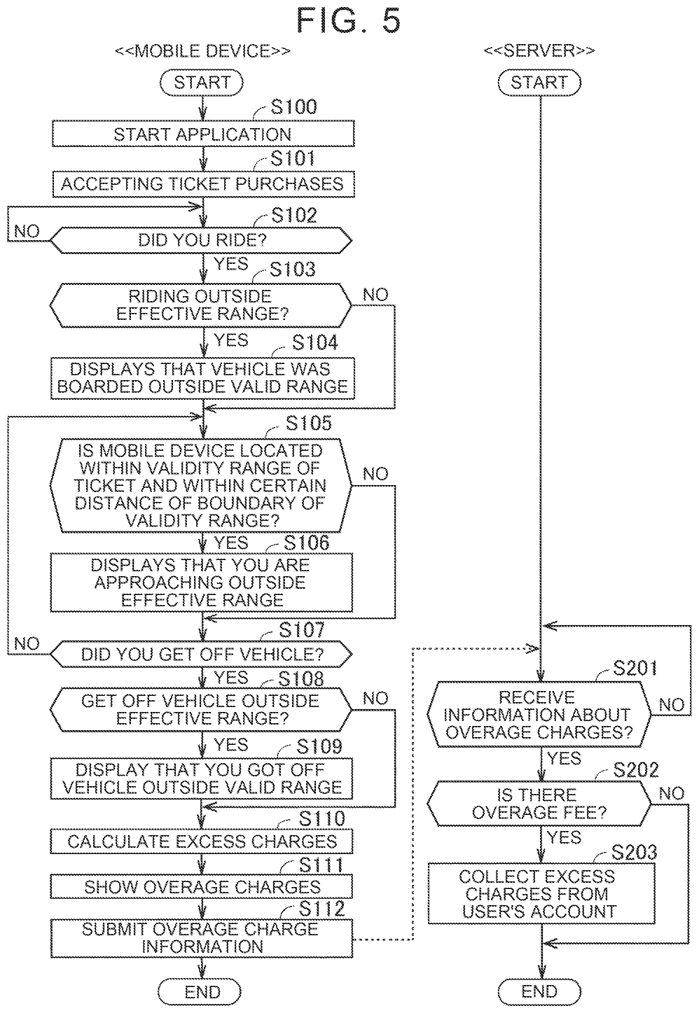

Next, sequence control between the mobile terminal 3 and the server 1 (a method of controlling the mobile terminal) will be described with reference to FIG. 5.

In S100, the processor 31 of the mobile terminal 3 (hereinafter simply referred to as the mobile terminal 3) starts controlling the application 333 in response to a user's touch operation or the like.

In S101, when the user performs an operation to purchase a ticket in the application 333, the mobile terminal 3 accepts the operation.

In S102, the mobile terminal 3 determines whether the user has boarded a transportation facility. For example, when the mobile terminal 3 is held over a card reader on a bus or an automatic ticket gate at a train station, it determines that the user has boarded a transportation facility. If it is determined that the user has boarded the vehicle (Yes in S102), the process proceeds to S103. If it is determined that the user is not in the vehicle (No in S102), the process of S102 is repeated.

In S103, the mobile terminal 3 determines whether the user boarded the vehicle outside the valid range of the ticket. For example, the mobile terminal 3 makes the above determination based on the information of the GPS module 36 of the mobile terminal 3, the position information of the automatic ticket gate over which the mobile terminal 3 is held up, and the like. If the user gets on the vehicle outside the effective range (Yes in S103), the process proceeds to S104. If the user gets on the vehicle within the valid range (No in S103), the process advances to S105.

In S104, the mobile terminal 3 displays on the display 35 that the user boarded the vehicle outside the valid range of the ticket. Specifically, when the user gets on the ticket within the valid range of the ticket, “valid” is displayed on the display screen of the display 35 to the right of the place where “ride” is written (see FIG. 4). Furthermore, if the user rides the vehicle outside the valid range of the ticket, “Out of Area” is displayed in the above location.

In S105, the mobile terminal 3 determines whether the mobile terminal 3 is located within the effective range and within a predetermined distance (for example, within 1 km) of the boundary of the effective range. For example, the mobile terminal 3 makes the above determination based on the effective range and the position information of the mobile terminal 3 based on the GPS module 36. If the mobile terminal 3 is located within the above area (Yes in S105), the process proceeds to S106. If the mobile terminal 3 is not located within the above area (Yes in S105), the process proceeds to S107.

Note that at this time, the mobile terminal 3 may display information on the distance to the boundary of the effective range and the time required to reach the boundary on the display 35.

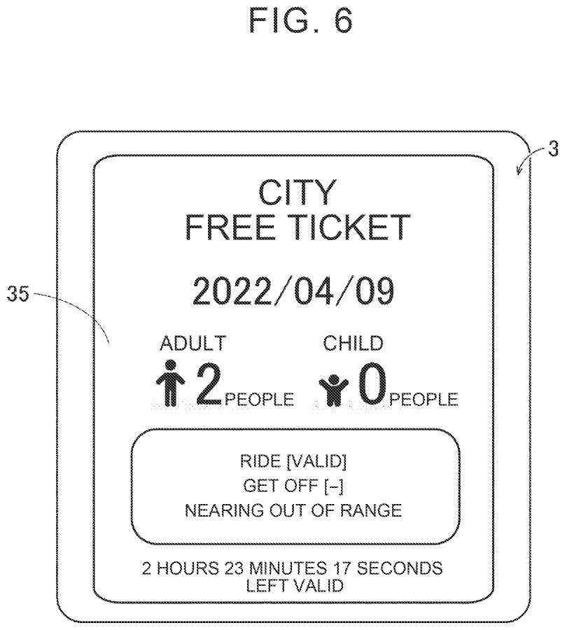

In S106, the mobile terminal 3 displays on the display 35 that the user is approaching outside the valid range of the ticket. In the example shown in FIG. 6, the message “Approaching outside the effective range” is displayed on the display 35.

Referring again to FIG. 5, in S107, the mobile terminal 3 determines whether the user has gotten off the transportation. For example, the mobile terminal 3 determines that the user has disembarked from the transportation by holding it over a card reader on a bus or an automatic ticket gate at a train station when boarding the bus, and then holding it over the card reader or automatic ticket gate again. If it is determined that the user has gotten off the vehicle (Yes in S107), the process proceeds to S108. If it is determined that the user has not gotten off the vehicle (No in S107), the process returns to S105.

In S108, the mobile terminal 3 determines whether the user got off the train outside the valid range of the ticket. For example, the mobile terminal 3 makes the above determination based on the information of the GPS module 36 of the mobile terminal 3, the position information of the automatic ticket gate where the mobile terminal 3 is held up when getting off the train, and the like. If the user gets off the vehicle outside the effective range (Yes in S108), the process proceeds to S109. If the user gets on the vehicle outside the effective range (No in S108), the process proceeds to S110.

The mobile terminal 3 displays on the display 35 that the user alighted outside the valid range of the ticket. Specifically, when the user gets off the train outside the valid range of the ticket, “outside area” is displayed on the display screen of the display 35 to the right of the place where it is written as “get off” (see FIG. 4). Furthermore, if the user gets off the ticket within the valid range of the ticket, “valid” is displayed in the above location.

In S110, the mobile terminal 3 calculates the excess charge based on the valid range of the ticket and the user's alighting position and boarding position. Note that if either the user's alighting position or boarding position is outside the valid range, an overage fee will be incurred. In other words, if both the boarding position and the alighting position are within the valid range, no excess charge will be incurred (the excess charge is 0).

In S111, the mobile terminal 3 displays the excess charge calculated in S110 on the display 35 (see FIG. 4).

In S112, the mobile terminal 3 transmits information on the excess charge calculated in S110 to the server 1. Note that the controls in S111 and S112 may be executed simultaneously.

In S201, the processor 11 of the server 1 (hereinafter simply referred to as server 1) determines whether information on excess charges has been received. If information on excess charges is received (Yes in S201), the process advances to S202. If the excess charge information has not been received (No in S201), the process of S201 is repeated.

In S202, the server 1 determines whether there is an excess charge (whether or not an excess charge has occurred). If there is an excess charge (Yes in S202), the process proceeds to S203. If there is no excess charge (No in S202), the process ends.

In S203, the server 1 executes a process of collecting an excess charge from the user's account (credit card account, etc.) based on the excess charge information transmitted from the mobile terminal 3 in S112. The process then ends. Note that the user's account may be registered in the server 1 in advance.

### Processing Flow When Entering a Destination

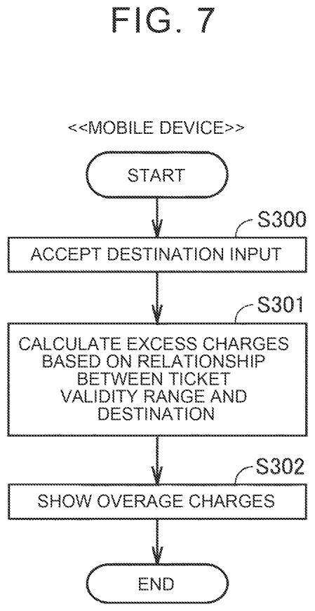

FIG. 7 is a processing flow of the mobile terminal 3 when the user inputs a destination in the application 333 of the mobile terminal 3.

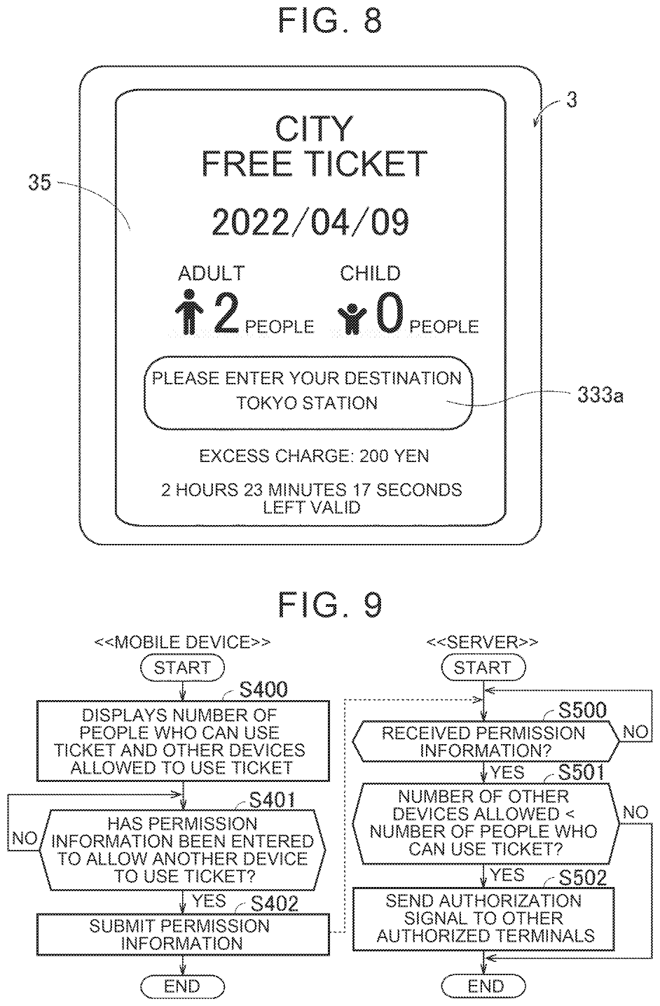

In S300, the mobile terminal 3 accepts a destination input operation by the user. Specifically, the user inputs a destination into a destination input field 333a (see FIG. 8) displayed on the display 35 when the application 333 is started.

In S301, the mobile terminal 3 calculates the excess charge based on the relationship between the valid range of the ticket and the destination input in S300. Note that in this case, the mobile terminal 3 may calculate the excess charge by considering the user's current location based on the information of the communication module 34 (FIG. 3).

In S302, the mobile terminal 3 displays the excess charge calculated in S301 on the display 35 (see FIG. 8).

### Process Flow for Authorizing Ticket Usage

FIG. 9 is a processing flow when allowing another user to use a ticket from the mobile terminal 3 to another terminal.

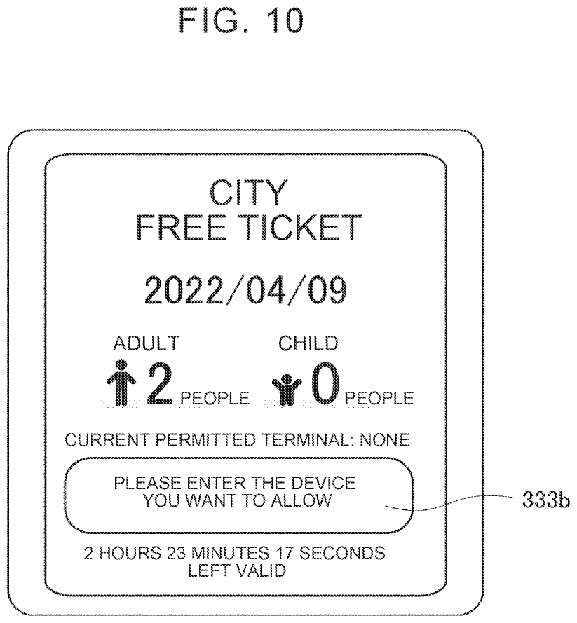

In S400, when the application 333 is activated, the mobile terminal 3 displays the number of people who can use the ticket and information about other terminals that are permitted to use the ticket on the display 35 (see FIG. 10). In the example shown in FIG. 10, the number of people who can use the ticket is two people (two adults). Furthermore, in the example shown in FIG. 10, there are no other terminals that are permitted to use the ticket at this time.

Referring again to FIG. 9, in S401, the mobile terminal 3 determines whether permission information that allows another terminal to use the ticket has been input. Specifically, the user inputs the destination into the permitted terminal input field 333b (see FIG. 10) displayed on the display 35 when the application 333 is started. The permitted terminal input field 333b may allow direct input, or may be a pull-down type from which pre-registered terminals can be selected. If permission information has been input (Yes in S401), the process advances to S402. If permission information has not been input (No in S401), the process of S401 is repeated.

In S402, the mobile terminal 3 transmits the permission information input in S401 (information on the terminal permitted to use the ticket) to the server 1.

In S500, the server 1 determines whether or not the permission information transmitted from the mobile terminal 3 in S402 has been received. If permission information has been received (Yes in S500), the process advances to S501. If permission information has not been acquired (No in S500), the process of S500 is repeated.

In S501, the server 1 determines whether the number of other terminals permitted to use the ticket is smaller than the number of people who can use the ticket. If the number of other permitted terminals is smaller than the number of people who can use the ticket (Yes in S501), the process advances to S502. If the number of other permitted terminals is greater than or equal to the number of people who can use the ticket (No in S501), the process ends. Note that the above-mentioned number of usable users also includes users of the mobile terminal 3.

In S502, the server 1 transmits a permission signal for permitting the use of the ticket to other terminals for which use of the ticket has been permitted by the user of the mobile terminal 3. The terminal that receives the permission signal can use the ticket.

As described above, in this embodiment, the display 35 of the mobile terminal 3 displays information on excess charges for using transportation outside the valid range of the ticket. Furthermore, the communication module 34 of the mobile terminal 3 transmits information regarding the payment of excess charges to the server 1 when the user uses transportation outside the valid range. As a result, the server 1 that has received the information regarding the payment of the excess charge executes the processing of paying the excess charge, thereby saving the user the trouble of paying the excess charge in cash. Further, since the information on the excess charge is displayed on the display 35, the user can obtain the information on the excess charge. This can give the user a sense of security compared to the case where the user cannot obtain information on excess charges.

In the above embodiment, an example was shown in which a notification (warning) is displayed on the mobile terminal 3 when the user is located within the valid range of the ticket and within a predetermined distance of the boundary of the valid range, but the present disclosure is not limited to this. For example, the above notification (warning) may be displayed when the user leaves the effective range.

In the above embodiment, an example was given in which the server that executes the process of collecting excess fees from the user's account and the server that executes the process of transmitting the permission signal to the terminal that is allowed to use the ticket are the same, but the present disclosure is not limited thereto. The servers that execute the above two processes may be different from each other.

In the above embodiment, an example is given in which the mobile terminal 3 executes the process of calculating the excess charge, the process of determining boarding (alighting) outside the valid range, the process of calculating the excess charge based on the destination, etc. Although shown, the present disclosure is not limited thereto. For example, the above process may be executed by a server that manages the application 333 (a server different from the server 1).

In the above embodiment, there are a process of displaying an excess charge based on destination information, a process of allowing another terminal to use the ticket, and a process of displaying a notification when approaching the boundary of the valid range. Although an example of execution has been shown, the present disclosure is not limited thereto. Only one or two of the above three processes may be executed, or none of the above three processes may be executed.

In the above embodiment, when the mobile terminal 3 is located within the valid range of the ticket and within a predetermined distance of the boundary of the valid range, the display 35 displays a message that the mobile terminal 3 is approaching outside the valid range. Although shown, the present disclosure is not limited thereto. For example, the above notification may be displayed when the user has arrived (or is expected to arrive) at the outermost stop or station in the effective range.

The embodiments disclosed this time should be considered to be illustrative in all respects and not restrictive. The scope of the present disclosure is indicated by the claims rather than the description of the embodiments described above, and it is intended that all changes within the meaning and range equivalent to the claims are included.

What is claimed is:

1. A user terminal of a user who uses a transportation facility using a ticket to which a valid range is set, the user terminal comprising:
a communication unit that communicates with a first server that manages electronic payment of a boarding fare for the transportation facility; and
a display unit, wherein
the display unit displays information on an excess fare for using the transportation facility outside the valid range, and
when the user uses the transportation facility outside the valid range, the communication unit transmits information on payment of the excess fare to the first server.

2. The user terminal according to claim 1, wherein the display unit
is configured such that information on a destination is able to be input through an input operation by the user, and
displays information on the excess fare that is determined based on the valid range and the destination.

3. The user terminal according to claim 1, wherein when the user is located within the valid range and at or within a predetermined distance from a boundary of the valid range, the display unit displays a notification indicating that the user is approaching an area outside the valid range.

4. A system including the user terminal according to claim 1, the system comprising:
the user terminal; and
a second server that communicates with the user terminal, wherein:
the user terminal
displays headcount information on the number of people who are allowed to use the ticket and permitted terminal information on another user terminal that is permitted to use the ticket,
allows inputting permission information for permitting the other user terminal to use the ticket through an input operation by the user, and
transmits the input permission information to the second server; and
when the number of other user terminals that are permitted to use the ticket is smaller than the number of people who are allowed to use the ticket, the second server transmits a permission signal to the other user terminal to permit use of the ticket.

5. A method of controlling a user terminal of a user who uses a transportation facility using a ticket to which a valid range is set, the method comprising the steps of:
displaying information on an excess fare for using the transportation facility outside the valid range; and
when the user uses the transportation facility outside the valid range, transmitting information on payment of the excess fare to a server that manages electronic payment of a boarding fare for the transportation facility.
